(19) United States
(12) Patent Application Publication
(10) Pub. No.: US 2022/0233277 A1
(43) Pub. Date: Jul. 28, 2022

(54) ORTHODONTIC METHODS AND DEVICES

(71) Applicant: Erskine Holdco Pty Ltd., North Curt Curl (AU)

(72) Inventor: Craig Mathew Erskine-Smith, North Curt Curl (AU)

(21) Appl. No.: 17/607,760

(22) PCT Filed: May 1, 2020
(86) PCT No.: PCT/AU2020/050439

§ 371 Date: Oct. 29, 2021

(30) Foreign Application Priority Data
May 1, 2019 (AU) 2019901481
May 3, 2019 (AU) 2019901514

(51) Int. Cl. A61C 7/08; A61C 5/00; A61C 7/30

(52) U.S. Cl. CPC A61C 7/08; A61C 7/30; A61C 5/007

(57) ABSTRACT

Disclosed is an orthodontic anchor unit to be fixed to a tooth, the unit including a mounting portion, the mounting portion having a length in the mesial-distal direction, a height in the occlusal-gingival direction, a thickness in the buccal-lingual direction and a rear surface fixable to the tooth; a projection extending transversely from the mounting portion in the buccal direction, the projection and the mounting portion defining a longitudinal cavity extending in the mesial-distal direction along a cavity axis, wherein the cavity is provided with an opening and configured to receive and locate an elongate splinting member that extends longitudinally into the cavity through the opening.

### FIELD

The present invention relates to orthodontic methods and devices, and in particular, but not exclusively, to orthodontic anchorage assemblies that are attached to and extend between adjacent teeth used in combination with tray force delivery based orthodontics as well as conventional orthodontic wire based force delivery.

### BACKGROUND

Orthodontics is a specialty of dentistry that deals with the diagnosis, prevention and correction of malpositioned teeth and jaws. It involves the repositioning, alignment or straightening of one or more teeth in the mouth to correct function and/or aesthetics.

Traditional methods of aligning teeth involve the use of wires and brackets configured to exert forces to the teeth enabling them to be moved in the arch. For instance, braces use brackets either in the form of molar bands which wrap around the molars or pads which can be adhered or bonded to the buccal enamel of adjacent teeth, to form a base foundation for a device that attaches thereto, such as an arch wire, a metal wire to apply straightening forces to the teeth in the arch. Traditional braces enable treatment of the entire arch and typically are used by highly trained orthodontists to address both functional and cosmetic issues.

However, there has been a trend in recent decades for a cosmetically focused treatment of teeth using clear plastic aligners since they offer a less conspicuous solution than metal wires and braces. Typically, a series or program of clear plastic trays or “aligners” are constructed and worn one after the other so as to progressively move the teeth to the required position.

However, while aligners are particularly effective and convenient for adjusting the anterior portion of the arch, there are challenges to overcome which are less common with traditional brackets, bands and braces.

A first challenge involves creating sufficient space in the arch to allow for adjustment of teeth. Quite often enamel is removed from between many teeth in the anterior or pre molar segments to make space, and this space created is repositioned and used to allow for the realignment of crooked or malaligned anterior teeth. However, since the molar teeth are used as anchorage units and used to exert force on the anterior teeth—especially where there are forces that are pulling the molars of the anchorage unit towards the mesial, it is quite common for these molar teeth to tilt quickly to the mesial or rotate instead of moving slowly forward in a bodily fashion. The rapid tilting and often rotating of these teeth causes the loss of the spaces created by stripping of precious enamel—with the effect that more enamel needs to be stripped later to provide sufficient space to achieve the realignment of the anterior teeth, and creating the double problem of an impaired and upset molar biting condition which can lead to temporomandibular joint dysfunction and other issues. Quite often the maximum amount of enamel has already been taken and there is no more available to strip to create more space. Even if there is more available, there are negative effects on the tooth and sometimes negative effects on the periodontal health of the teeth involved where the roots are too close together.

The applicant's prior application WO2017/020062 proposes the use of anchorage brackets which can be adhered or bonded to the buccal enamel of adjacent teeth, and in particular molars, usually the first and second molars. The brackets forming the anchors may be glued or bonded to the teeth and form a base foundation for a device that attaches thereto, such as an arch wire, a metal wire, a metal tube, a zirconium or fibre glass rod, or the like. It is also known to replace the pads with molar bands which wrap around the teeth in order to attach firmly to the teeth.

The rigid fixation, or splinting, of two adjacent molars has the objective of anchoring the adjacent teeth in position to inhibit relative movement between the anchor teeth and therefore inhibit the overall movement of the bonded anchorage teeth when they are subjected to mesial or distal forces from aligners. The resistance to movement, for instance to tilting, of two splinted teeth is significantly greater than the sum of the two teeth as individual units.

Accordingly, it has been proposed to splint adjacent teeth by means of rigid fixation of a splinting bar, thereby providing a dramatic increase in the anchorage value of these teeth.

Other previously known anchorage devices may include trans palatal arches, temporary implants (which may be referred to as temporary anchorage devices or tads), head gear or name buttons, and may involve palatal discomfort and/or general face and head discomfort from surgery. These previously known anchorage devices may not be totally effective as anchors, especially if the implant fails (as they often do), or if the vectors of force created by attaching to these off-centre implants cause unexpected or unfavourable forces to act on the teeth and move them in directions that are not desirable.

Another problem revolves around the ability of the aligner to register a sufficient attachment to a molar. Thus the clear plastic aligners may be used in combination with composite resin attachments—these attachments are small projections from the teeth that enable the plastic aligner to have purchase on the tooth by way of their engagement with the undercut underneath the attachment, to enable the forces programmed into the aligner to be transmitted effectively through to the tooth without significant slippage.

Additionally, the aligners can be difficult to position fully onto the teeth, and to remove, especially if the attachments have shapes that engage and hold the aligner to the tooth very firmly.

Additionally, conventional attachments are usually shaped in a way to avoid aggressive undercuts rather than to create them as it would be desirable to have hooks to attach to elastic bands and power chains etc. Button shaped attachments often have to be placed onto the teeth in addition to conventional attachments in order to use such elastics. Alternatively, notches can be cut into the plastic aligner tray to provide an attachment point for the elastics, and each tray in a typical series of 20 or 30 has to be modified accordingly or created with attachment points. This creates a lot of unnecessary work and irritation.

One example of a known device that is used for the splinting of molar teeth has a disadvantage that the teeth are assumed to be in the optimal position and ready to be ‘frozen’ or fixed in that position. However, quite often teeth, including the molars, present in a crooked or malaligned condition, and they would thus ideally be straightened before they can be splinted and used as anchorage.

Splinting freezes the teeth in the position in which they are found at the time that the splint is applied. Whilst existing splinting devices may be aesthetically pleasing and may be made of zirconium, fiberglass, or other tooth-coloured materials, such devices cannot be used when subsequent individual movements of teeth are required. Plastic aligner trays rely on conventional composite resin attachments being placed on the molars, moving the molars into the optimal position, and then it is possible to freeze them in that position by adding the splinting device after moving them. However, this approach requires that the attachments used to move the teeth be cut off and replaced with another bonded splinting device subsequently in order to move the teeth, which would be inefficient.

It would therefore be desirable to provide a multipurpose attachment for individual movement, enhancement of clear tray retention and transmission of forces to rotate the teeth and then such multipurpose attachment be utilised as the foundation for a splinting device, without the need for removal and replacement with a separate splinting device.

As not all splinting devices are required to be used in the distalisation of anterior teeth (anterior teeth may be splinted to distalise posterior teeth), it would therefore also be desirable to provide a system for splinting both anterior and posterior teeth. It would also be desirable to provide a system which is aesthetically pleasing, able to accommodate different sized and shaped wire or splinting members, and to also have the ability to accept any brand of clear trays or aligners.

It would also be desirable to be able to move teeth, prior to splinting using both of the two most common modalities in orthodontics which are clear plastic trays, and brackets/wires. Therefore, it would also be desirable to provide a bracket that is able to accept traditional orthodontic wire, so as to allow application of force to the teeth to be straightened using a straight wire technique, and to ultimately be able to splint the teeth together without the removal of the bracket.

### OBJECT OF THE INVENTION

It is the object of the present invention to overcome or substantially ameliorate the above disadvantages.

### SUMMARY OF INVENTION

There is disclosed herein an orthodontic method for splinting and repositioning teeth in a dental arch of a patient utilizing aligner trays, said method including the steps of:

fixing a first orthodontic attachment/anchor unit to a first tooth in the dental arch;

fixing a second orthodontic attachment/anchor unit to a second tooth in the dental arch;

splinting the first and second teeth together by rigidly connecting the first and second orthodontic attachment/anchor units with a substantially rigid elongate splinting member thereby providing orthodontic anchorage;

applying a sequence of aligner trays engaging at least one of the first and second orthodontic attachment/anchor units and a third tooth in said dental arch so as to reposition said third tooth.

Preferably, the method includes the further step prior to the step of splinting the first and second teeth together of:

applying a preliminary sequence of aligner trays to engage at least one of the first and second orthodontic attachment/anchor units to thereby reposition at least one of the first and second teeth.

Preferably, said elongate splinting member includes a hook for the attachment of an orthodontic device including one of an inter arch elastics, c-chain or elastic thread.

Preferably, the method includes the further step of:

removing said rigid elongate splinting member and said first and second orthodontic attachment/anchor units.

Preferably, each orthodontic attachment/anchor unit includes:

a mounting portion, the mounting portion having a length in the mesial-distal direction, a height in the occlusal-gingival direction, a thickness in the buccal-lingual direction and a rear surface fixable to the tooth;

a projection extending transversely from the mounting portion in the buccal-lingual direction, the projection and the mounting portion defining a longitudinal cavity extending in the mesial-distal direction along a cavity axis, wherein the cavity is provided with an opening and configured to receive and locate said elongate splinting member that extends longitudinally into the cavity through the opening.

Preferably, the projection includes an exterior facing surface having an arcuate profile.

Preferably, the cavity is elongate in the occlusal-gingival direction.

Preferably, the cavity has a vertically elongate D-shaped cross section.

Preferably, the mounting portion is perforated with a plurality of apertures extending therethrough.

Preferably, the apertures are arranged in a grid array thereby forming a mesh like structure to provide mechanical engagement for bonding/cement agents and thereby affix the unit to said tooth.

Preferably, the apertures narrow toward the tooth engaging surface to provide mechanical engagement for bonding/cement agents.

Preferably, the projection includes a passage in communication with the cavity for receiving cement for delivery to the cavity to secure the elongate splinting member within to the cavity.

Preferably, the anchor is formed from any one of ceramic, metal, fibreglass, plastic and sapphire.

Preferably, the projection includes a longitudinal slot extending along the cavity axis, said allowing lateral insertion of the elongate splinting member into the cavity.

Preferably, the projection is formed of at least one flange extending transversely from the mounting portion thereby to define the longitudinal slot.

Preferably, the projection is formed of at a first flange extending from an upper portion of the mounting portion, and a second flange extending from a lower portion of the mounting portion to define the longitudinal slot therebetween.

Preferably, the first cavity and the second cavity align longitudinally when fixed to adjacent teeth.

Preferably, the elongate splinting member is a solid rod.

Alternatively, the elongate splinting member is a hollow tube.

Preferably, the elongate splinting member has a non circular cross section.

Preferably, the elongate splinting member has an oval or elliptical cross section.

Preferably, the elongate splinting member has an elongate D-shaped cross section corresponding to vertically elongate D-shaped cross sections of the respective cavities of the first and second orthodontic attachment/anchor units.

Preferably, the projection includes transverse passage extending to the respective cavity to provide for the delivery of a flowable substance to each cavity.

Preferably, the step splinting the first and second teeth together includes fixing respective ends of the elongate splinting member to the first and second orthodontic attachment/anchor units with a flowable settable substance.

Preferably, the flowable settable substance includes one of a self-curing, light curing or a dual curing resin cement or glass ionomer cement.

Alternatively, the method includes the further step a further step prior to the step of splinting the first and second teeth together, of:

repositioning at least one of the first and second teeth by means of orthodontic wire., and may include inserting a preformed insert into a cavity disposed on one of the first and second orthodontic attachment/anchor units, said insert for receiving an orthodontic wire.

There is further disclosed herein an orthodontic attachment/anchor unit to be fixed to a tooth, the unit including:

a mounting portion, the mounting portion having a length in the mesial-distal direction, a height in the occlusal-gingival direction, a thickness in the buccal-lingual direction and a rear surface fixable to the tooth;

a projection extending transversely from the mounting portion in the buccal direction, the projection and the mounting portion defining a longitudinal cavity extending in the mesial-distal direction along a cavity axis, wherein the cavity is provided with an opening and configured to receive and locate an elongate splinting member that extends longitudinally into the cavity through the opening.

Preferably, the projection includes an exterior facing surface arcuate.

Preferably, the cavity is elongate in the occlusal-gingival direction.

Preferably, the cavity has a vertically elongate D-shaped cross section.

Preferably, the mounting portion is perforated with a plurality of apertures extending therethrough.

Preferably, the apertures are arranged in a grid array thereby forming a mesh like structure to provide mechanical engagement for bonding/cement agents and thereby affix the unit to said tooth.

Preferably, the apertures narrow toward the tooth engaging surface to provide mechanical engagement for bonding/cement agents.

Preferably, the projection includes a passage in communication with the cavity for receiving cement for delivery to the cavity to secure the elongate splinting member within to the cavity.

Preferably, the anchor includes any one of metal, plastics, ceramic, composite, or other rigid or semi-rigid material or preferably a fiberglass reinforced engineering plastic material.

Preferably, the projection includes a longitudinal slot extending along the cavity axis, said allowing lateral insertion of the elongate splinting member into the cavity.

Preferably, the projection is formed of at least one flange extending transversely from the mounting portion thereby to define the longitudinal slot.

Preferably, the projection is formed of at a first flange extending from an upper portion of the mounting portion, and a second flange extending from a lower portion of the mounting portion to define the longitudinal slot therebetween.

There is further disclosed herein an orthodontic anchorage assembly including:

a first orthodontic attachment/anchor unit as recited above to be fixed to a first tooth;

a second orthodontic attachment/anchor unit as recited above to be fixed to a second tooth; and

a substantially rigid elongate splinting member receivable within the first cavity and the second cavity and extending between the first unit and the second unit; and

a settable material located in the first cavity and the second cavity, and engaging the elongate splinting member to rigidly fix the elongate splinting member to the first unit and the second unit.

Preferably, the first cavity and the second cavity align longitudinally when fixed to adjacent teeth.

Preferably, the elongate splinting member is a solid rod.

Preferably, the elongate splinting member is a hollow tube.

Preferably, the elongate splinting member has a non circular cross section.

Preferably, the elongate splinting member has an oval or elliptical cross section.

Preferably, the elongate splinting member has an elongate D-shaped cross section corresponding to vertically elongate D-shaped cross sections of the respective cavities of the first and second orthodontic attachment/anchor units

There is disclosed herein an orthodontic device including:

a base to be fixed to a tooth surface, the base providing a cavity extending inwardly from a surface of the base from a base opening in the base surface, the cavity having a transverse cross section; and

a preformed insert to be located in the cavity by insertion therein through the base opening, and having a cross section so that the insert at least substantially fills the cavity, the insert having a passage extending inwardly of the insert from an insert opening in an insert surface of the insert, with the insert being configured so as to cooperate with the cavity so that the insert opening is exposed by the base opening.

Preferably, the cavity extends through the base from the base opening, to a further base opening on the base surface.

Preferably, said passage extends entirely through the insert from the insert opening to a further insert opening in the insert surface.

Preferably, the base has a transverse passage extending inwardly to the cavity to provide for securing the insert to the base.

Preferably, said cavity has a non-circular transverse cross section.

Preferably, the cavity transverse cross section is generally oval.

Preferably, said passage has a non-circular transverse cross section.

Preferably, the transverse cross section of the passage is square or rectangular.

There is further disclosed herein an orthodontic assembly including the above anchor device, with the above device being a first device, with the assembly including a second device, the said second device including:

a second base affixed to a further tooth surface, the second base providing a second cavity extending inwardly from a second surface of the second base from a second base opening in the second base surface, the second cavity having a second transverse cross section; and

a second preformed insert to be located in the second cavity by insertion therein through the second base opening, and having a second cross section so that the second insert at least substantially fills the second cavity, the second insert having a second passage extending inwardly of the second insert from a second insert opening in a second insert surface of the second insert, with the second insert being configured so as to cooperate with the second cavity so that the second insert opening is exposed by the second base opening; and wherein the assembly further includes;

an elongated connection member extending from the first insert to the second insert.

Preferably, the first insert is fixed to the first base, and the second insert is fixed to the second base.

There is further disclosed herein an orthodontic anchorage assembly including:

a first base to be fixed to a tooth surface, the base providing a cavity extending inwardly from a surface of the base from a base opening in the base surface, the cavity having a transverse cross-section;

a second base to be fixed to a further tooth surface, the second base providing a second cavity extending inwardly from a surface of the second base from a base opening in the second base surface, the second cavity having a transverse cross-section; and

a rod extending between the first base and the second base, and extending into the first cavity and the second cavity; and

a material located in the first cavity and the second cavity, and engaging the bar to fix the bar to the first base and the second base.

Preferably, the rod is solid.

In an alternative preferred form, the rod is a tube.

Preferably, a wire extends through the tube.

Preferably each base has a transverse passage extending to the respective cavity to provide for the delivery of a flowable substance to each cavity.

There is still further disclosed herein an orthodontic device including:

a base, the base having a surface to be fixed to a tooth surface, and an exposed surface projecting away from the base surface; and wherein

the exposed surface has a surface extending at an acute angle to the base surface to engage an aligner to engage a patient's teeth.

Preferably, said acute angle is 35° to 65°.

Most preferably, said acute angle is approximately 60°.

Preferably, the inclined surface has a direction of extension that includes a first length generally parallel to the base surface, and a second length generally perpendicular to the base surface.

Preferably, the base surface has a length that is to extend away from a wearer's gums, with said first surface being approximately 20 to 80% of said base length.

Preferably, said first surface is approximately 25% of said base length.

Preferably, said device has a depth extending generally perpendicular from the tooth surface, with said second length being approximately 40 to 80% of said depth.

Preferably, said inclined surface is generally planar.

The device may include a mesh of fibreglass and/or resin, metal or ceramic or sapphire crystal.

### BRIEF DESCRIPTION OF DRAWINGS

Preferred forms of the present invention will now be described by way of example with reference to the accompanying drawings wherein:

FIG. 1 is a schematic parts exploded isometric view of an orthodontic device;

FIG. 2 is a schematic parts exploded isometric view of the device of FIG. 1 being secured to two adjacent teeth;

FIG. 3 is a schematic end elevation of the device view of FIGS. 1 and 2;

FIG. 4 is a schematic end elevation of the device of FIGS. 1 and 2 with an insert of the device removed;

FIG. 5 is a schematic isometric view of the device of FIGS. 1 and 2;

FIG. 6 is a further schematic isometric view of the device of FIGS. 1 and 2;

FIG. 7 is a schematic isometric view of a modification of the device of FIGS. 1 and 2;

FIG. 8 is a schematic side elevation of the device of FIG. 7;

FIG. 9 is a schematic isometric view of a modification of the orthodontic device of FIGS. 1 to 8;

FIG. 10 is a schematic end elevation of the orthodontic device of FIG. 9;

FIG. 11 is a schematic side elevation of the orthodontic device of FIG. 9; and

FIG. 12 is a schematic side elevation of a modification of the orthodontic device of FIGS. 9, 10 and 11.

FIG. 13 is a schematic isometric view of an orthodontic anchorage assembly in accordance with the present invention;

FIG. 14 shows the orthodontic anchorage assembly of FIG. 13 including a flexible wire;

FIG. 15 shows all views of a first anchor for the orthodontic anchorage assembly shown in FIG. 13;

FIG. 16 shows all views of a second anchor for the orthodontic anchorage assembly shown in FIG. 13;

FIG. 17 shows all views of a third anchor for the orthodontic assembly shown in FIG. 13;

FIG. 18 shows the orthodontic assembly including the anchor of FIG. 16;

FIG. 19 shows the orthodontic assembly including the anchor of FIG. 17;

FIG. 20 shows the orthodontic assembly including the anchor shown in FIG. 16 and the anchor shown in FIG. 17;

FIG. 21 shows a schematic isometric view of a modification of the device of FIG. 17;

FIG. 22 shows a schematic front view of the device of FIG. 21;

FIG. 23 shows a schematic top view of the device of FIG. 21;

FIG. 24 shows a schematic side cross-sectional view of the device of FIG. 21 taken along section line B-B of FIG. 22;

FIG. 25 shows a schematic side cross-sectional view of the device of FIG. 21 taken along section line C-C of FIG. 22;

FIGS. 26 to 32 show a portion of a dental arch and display schematic perspective representations of a method of installing a pair of anchors and an orthodontic anchorage assembly in accordance with the invention; and

FIG. 33 shows a schematic perspective representation of an alternative orthodontic anchorage assembly in accordance with the invention.

### DESCRIPTION OF EMBODIMENTS

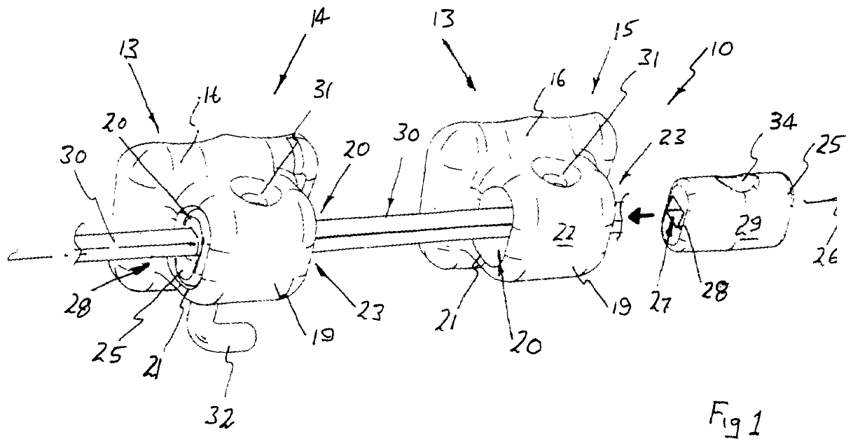

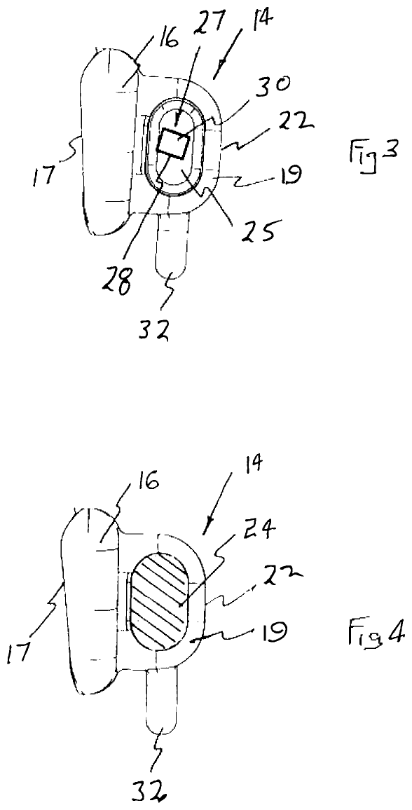

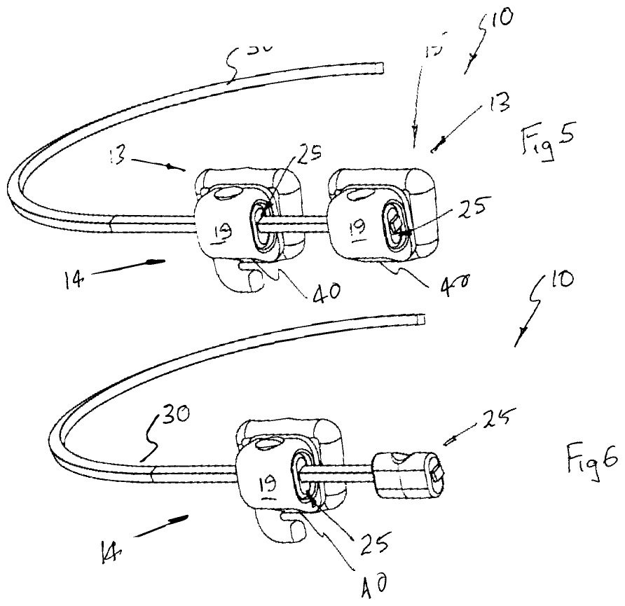

FIGS. 1 to 6 of the accompanying drawings show a first embodiment of an orthodontic assembly 10 that is to be fixed to adjacent teeth 11 and 12.

The assembly 10 includes a first pad or base 14, and a second pad or base 15.

Each base 14, 15 includes a mounting portion 16 providing a surface 17, with each surface 17 being fixed to the surface 18 of the respective tooth 11 or 12.

Fixed to or formed integral with the mounting portion 16 of each base 14, 15 is a projection 19, with each projection 19 providing a cavity 20 that extends inwardly from an opening 21 in the surface 22 of each projection 19.

In this embodiment, each of the cavities 20 extends entirely through its associated projection 19 so that each cavity 20 extends from its opening 21, to its further opposite opening 23.

In this embodiment, the cavities 20 are of an oval cross section 24, however it should be appreciated that other cross sections may be employed. Preferably the cross section is non-circular.

Each of the cavities 20 receives a respective insert 25, with each insert 25 being preformed and insertable in a respective one of the cavities 20. As best seen in FIG. 3, each insert 25 substantially fills its associated cavity 20, and is of a complementary transverse cross section to the cross section 24, so that each insert 25 cannot move angularly about the axis 26 that passes substantially essentially longitudinally through each cavity 20.

The first base 14 and its insert 25 provide a first orthodontic device 13, and the second base 15 and insert 25 provide a second orthodontic device 13.

Each insert 25 has a longitudinal passage 27 that in this embodiment extends entirely longitudinally through respective insert 25, so as to extend between opposite openings 28 in the external surface 29 of each insert 25.

In this embodiment, each passage 27 is generally square or rectangular in transverse cross section, however other cross sections may be employed and are preferably non-circular.

Extending between and through the inserts 25, so as to be located in the passages 27, is an orthodontic arch wire 30 being part on the device 13. In this embodiment wire 30 has a transverse cross section that is complementary to the transverse cross section of the passages 27, but is longitudinally movable through at least one of the passages 27.

The wire 30 extends along the axis 26, and may extend beyond one or both anchors 14,15.

In this embodiment, as the wire 30 and passages 27 are of a non-circular transverse cross section, the wire 30 cannot rotate relative to the inserts 25 about the axis 26.

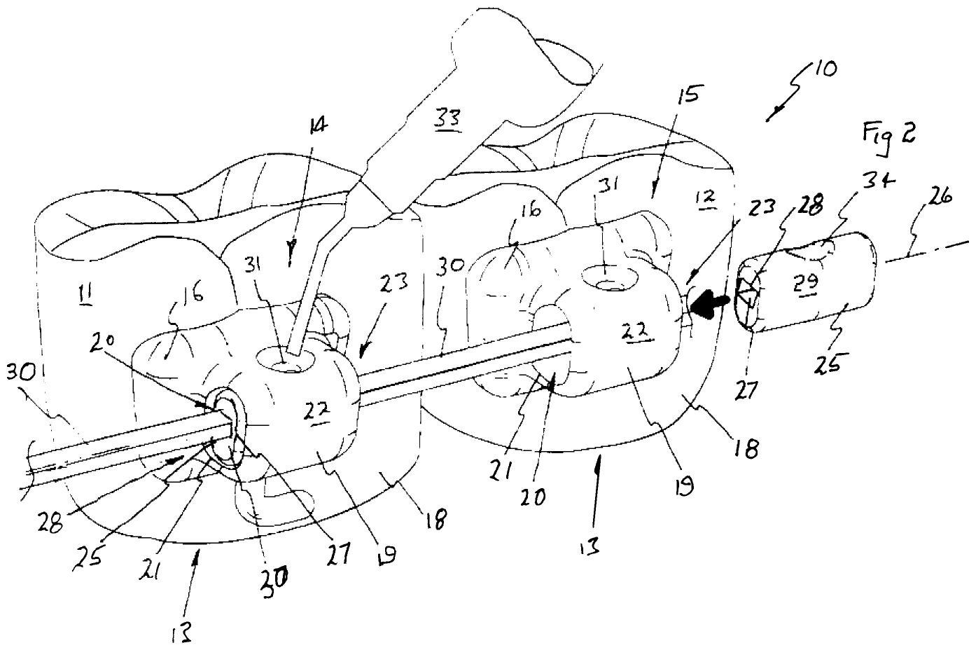

Each projection 19 is provided with a duct 31 that communicates with the associated passage 20, to provide for fixing of each insert 25 to its associated projection 19. In one embodiment, a threaded fastener may be inserted in each of the ducts 31 to engage the associated insert 25, while in an alternative embodiment (as shown in FIG. 2), a flowable but settable material is injected through each duct (transverse passages) 31 to engage the associated insert 25, so that upon setting, each insert 25 is fixed to a respective projection 19. As a particular example the flowable substance may be an adhesive and delivered by the applicator 33. Preferably the inserts have a recess 34 into which the substance sets to at least aid in securing the inserts 25 fixed to the bases 14,15.

If so required one or both of the projections 19 may be provided with a hook or other projection 32 that would be provided to assist in the attachment of other orthodontic devices such as elastics to the orthodontic assembly 10.

In the above described preferred embodiments, the wire 30 is generally straight. However, the wire 30 may be bent to a desired configuration to accommodate the position and inclination of the teeth 11 and 12.

In respect of the above embodiments, the bases 14 and 15 may be formed of metal, plastics, ceramic or other rigid or semi-rigid material. Additionally, the inserts 25 may also be formed of metal, plastics, ceramic or other rigid or semi-rigid material.

The inserts 25 are retained in the cavities 25 by screws, cement or silicone, however it should be appreciated that the inserts 25 are removably secured within the cavities 20 so that the inserts 25, and associated wire 30 can, be removed and replaced. This enables the bases 14 and 15 to receive replacement inserts 25 and a wire 30 of a different configuration. This has the advantage that the bases 14 and 15 do not need to be removed thereby.

FIGS. 7 to 12 show another embodiment of the orthodontic assembly 10 in which like reference numbers have been used to indicate like features relative to the first embodiment. The assembly 10 has been modified so that a substantially rigid elongated rod or connection member 35 is fixed to the pads, or bases 14, 15 so as to not be movable relative thereto. In particular, the rod 35 would project into each of the cavities 20, with the rod 35 being fixed to the bases 14, 15 by applying to each of the cavities 20, a flowable substance that sets. Alternatively, a threaded fastener may be inserted in each of the passages 31 to engage the rod 35.

The rod 35 may be solid, or alternatively, may be tubular in configuration. If tubular in configuration, the rod 35 may receive the wire 30, that is movable relative to the rod 35.

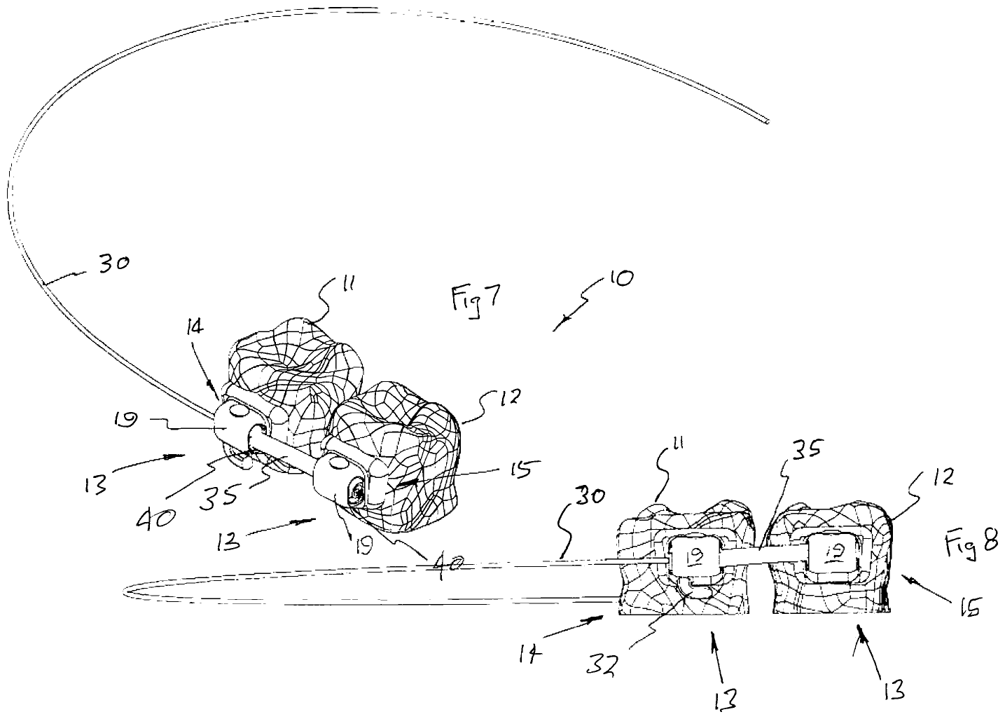

A further advantage of the above embodiments is that they allow the operator to place at least one of the bases 14, 15 to level and align the teeth (FIGS. 1 to 6), remove an insert 25, and then use the same base 14, 15 to splint two or more teeth (FIGS. 7 and 8).

A still further advantage of the above embodiments is that the bases 14 and 15 enable the assembly 10 to act in respect of splinting and/or anchorage.

With reference to FIGS. 1 to 6, the orthodontic anchorage assembly 10, by use of the wire 30, may be used to adjust the position and/or inclination of teeth. The same pads, or bases 14, 15 may then be used, by removal of the inserts 35 and wire 30, as an orthodontic anchorage by fixing the rod 35 to the bases 14, 15. Accordingly, the anchors 14, 15 can be used to perform a number of different tasks. This has a particular advantage that the anchors 14, 15 do not need to be removed should the task alter.

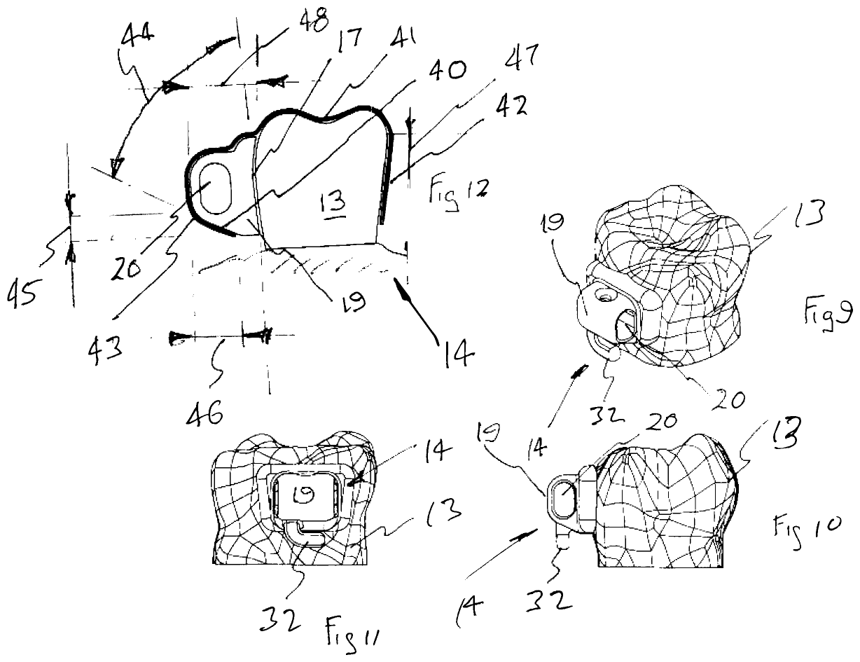

With reference to the embodiments of FIGS. 5 to 12, the bases 14, 15 are provided with an inclined surface 40 that aids in the application and removal of a plastic aligner (tray) 41 best seen in FIG. 12. The plastic aligner 41 has a rear portion 42 that engages the rear surface of the tooth 11, and a front portion 43 that extends over the projection 19, and more particularly extends along the surface 40 by an acute angle 44. Preferably the angle 44 is approximately 35 to 60°, and most preferably 45°.

The inclined surface 40 has a first length 45, extending generally parallel to the surface 17, and a second length 46 extending generally perpendicular to the surface 17. Preferably the length 45 is 20 to 80% of the length 47 of the surface 17, and most preferably about 25%. The length 46 is approximately 60 to 80° of the depth 48 of the base 14.

In one embodiment, the base 14 can be provided without a hook 32, while in an alternate embodiment a hook 32 is provided to facilitate the attachment of other orthodontic apparatus and/or means for applying teeth aligning forces.

The base 14 is less retentive but still retentive enough to be used as an attachment. The base 14, unlike conventional attachments may have a hook 32 which enables elastics to be used to rotate problem teeth and also to be used for inter-arch elastics such as class II and class III elastics—and also to be used for C chain and other orthodontic uses. The base 14 can be used as an attachment in order to secure the clear aligners to the teeth and help transmit the forces programmed in the aligner to the teeth without slippage, and at the same time, as an equivalent to a button for elastic to attach to, when a hook is used

Accordingly, the above embodiment has the advantage that each base may be used first to serve as an attachment to align the molars with respect to one another and subsequently, as a bracket for splinting two or more molars or premolars together to provide an anchorage device.

One advantage of the above embodiment is that the dentist or orthodontist can run wire in a segment of the mouth, or a quadrant or an arch or the whole mouth, to get more predictable and rapid orthodontic movement than is usually possible with clear aligner (trays) 41—and then to remove the insert and carry on with the clear plastic alignment trays 41 and then at the end of that, to splint the teeth if required. They can also use the bases with the special sloping surface to move the malaligned teeth, especially molars, into good occlusion and position using clear aligners, and then splint them together for anchorage or stability purposes.

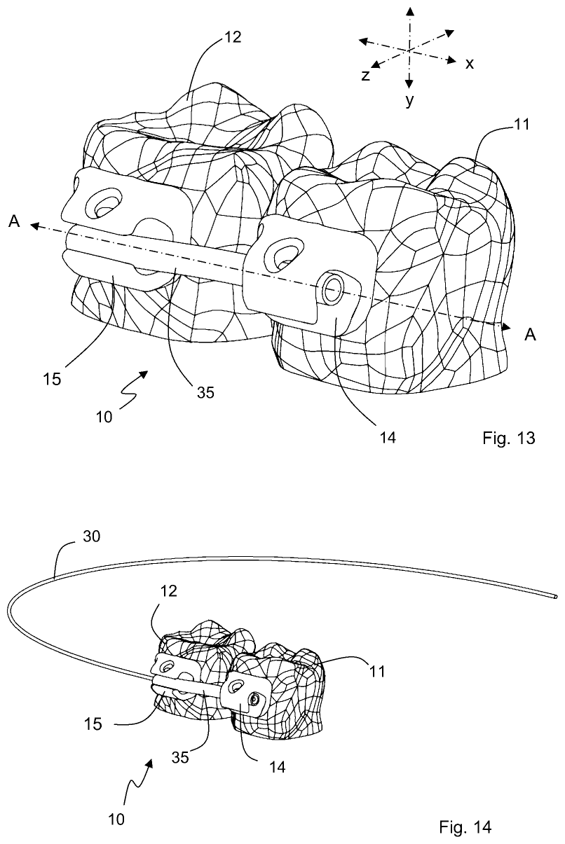

FIGS. 13 to 20 of the accompanying drawings show a further embodiment of the orthodontic anchorage assembly 10 in which like reference numbers have been used to indicate like features relative to the first and second embodiments. However, is this embodiment the orthodontic attachment/anchor devices 13 are configured as multipurpose orthodontic attachment/anchor units 14, 15 serving as either an attachment as may be used with an aligner tray and/or providing an anchor component of the orthodontic anchorage assembly 10. The assembly 10 includes a first attachment/anchor unit 14 and a second attachment/anchor unit 15. Each of the attachment/anchor units 14, 15 is fixable to a respective tooth 11, 12, and a substantially rigid elongate splinting member, shown as tube 35 extends between the attachment/anchor units 14, 15 and is affixed within respective cavities 20 without use of an insert component.

While in this embodiment, and as best see in FIG. 14, the tube 35 houses a flexible wire, preferably in the form of an orthodontic arch wire 30, as noted, in other embodiments the tube 35 may take the form of a substantially rigid, solid rod or bar to form the splinting member. Preferably, the rod is sufficiently strong to withstand vertical forces which may be applied during chewing, particularly to the unsupported section spanning between each of the attachment/anchor units 14, 15. In this regard, in some embodiments the rod may have a profile taller than it is wide.

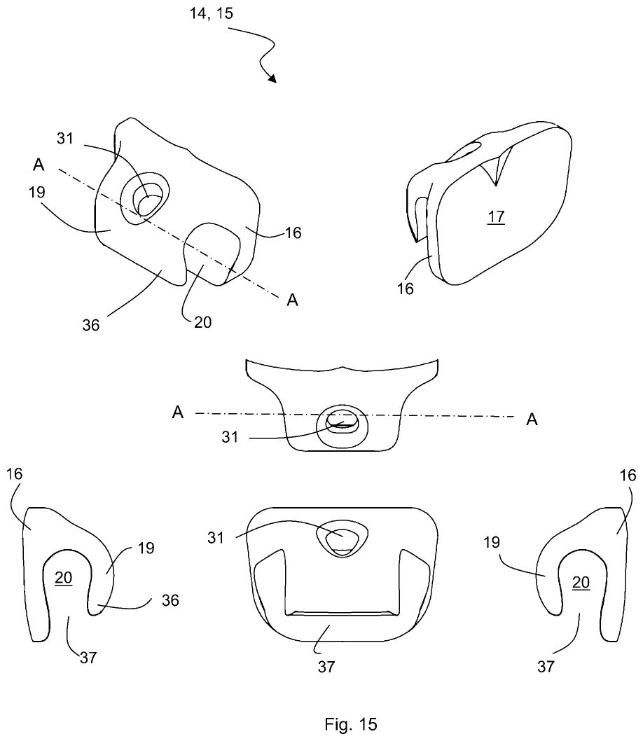

FIGS. 15, 16 and 17 show different embodiments of the attachment/anchor units 14, 15. Each of the attachment/anchor units 14, 15 includes a mounting portion 16 extending between a first end and a second end, the mounting portion having a length in the mesial-distal direction, a height in the occlusal-gingival direction, a thickness in the buccal-lingual direction (indicated in FIG. 13 for the sake of clarity by arrows x, y and z respectively) and a rear surface 17 with each rear surface 17 being fixable to each respective tooth 11, 12. A projection 19 extends transversely from the mounting portion in the buccal-lingual direction defining a cavity 20 having a cavity axis A-A that extends longitudinally through the projection generally parallel to the rear surface in the mesial-distal direction from an opening 21 in an end surface of the projection.

Referring to FIG. 15, the projection 19 is in the form of a flange 36 extending transversely from the mounting portion 16 and forming an n-shaped bracket. In this embodiment the mounting portion 16 and the flange 36 define the cavity 20. The cavity 20 having a lateral slot 37 extending longitudinally the length of the cavity 20.

Preferably, the cross section of the cavity is non-circular. In this embodiment the cavity 20 has a generally oval cross section having generally orthogonal major and minor dimensions with the major dimension orientated in the occlusal-gingival direction being larger than the minor dimension. Preferably the cavity provides a loose fit for the rod, both which may allow for insertion of the rod, a degree of misalignment between the cavities when the attachment/anchor units are set on respective teeth and space for receiving flowable settable material. It should be appreciated however, that other cross sections may be employed as will be seen.

In this embodiment, the cavity 20 is sized to accommodate a 1.3 mm rod, or tube 35. The 1.3 mm diameter tube or rod 35, enables the attachment/anchor unit 14, 15 to be used as a splint and then, in the case of a tube, accommodate a wire 30 that may be used to move other teeth.

The flange 36 includes a passage, or duct 31 in communication with the cavity 20 to allow for insertion of a flowable but settable material such as cement to engage the rod or tube 35 so that upon setting, the rod or tube 35 is fixed to the unit 14, 15.

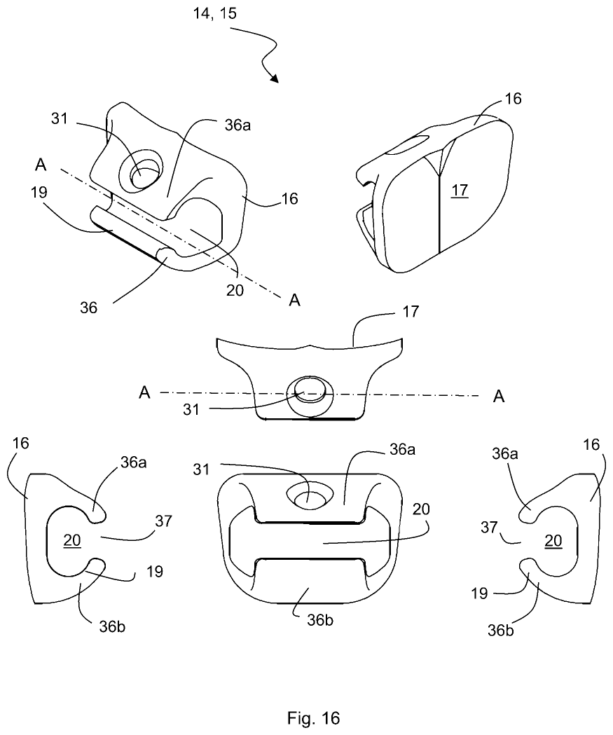

FIG. 16 shows another embodiment of an attachment/anchor unit 14, 15. In this embodiment the projection 19 includes a first flange 36a extending from an upper portion of the base 16, and a second flange 36b extending from a lower portion of the base 16, forming a C-shaped bracket. The first and second flanges 36a, 36b and the base 16 define the cavity 20, and the first and second flanges 36a, 36b define a longitudinal slot 37. The slot 37 extends longitudinally the length of the attachment/anchor unit 14, 15.

The first flange 36a includes a passage, or duct 31 in communication with the cavity 20 to allow for insertion of a flowable but settable material such as cement to engage the tube or rod 35 so that upon setting, the rod or tube 35 is fixed to the unit 14, 15.

The rod or tube 35 extends between the attachment/anchor units 14, 15 and if used with a wire 30, the wire may extend beyond the attachment/anchor units 14, 15.

In both embodiments described above, the slot 37 allows for easy fitting of the rod 35 or wire 30 within the cavity 20. Preferably, the attachment/anchor units 14, 15 are alternated between adjacent teeth 11, 12 so that the respective slots 37 are offset about a cavity axis A-A by about 90 degrees. This provides for easy transverse insertion of the rod 35 or wire 30 rather than having to thread the rod 35 or wire 30 longitudinally through a series of cavities 20.

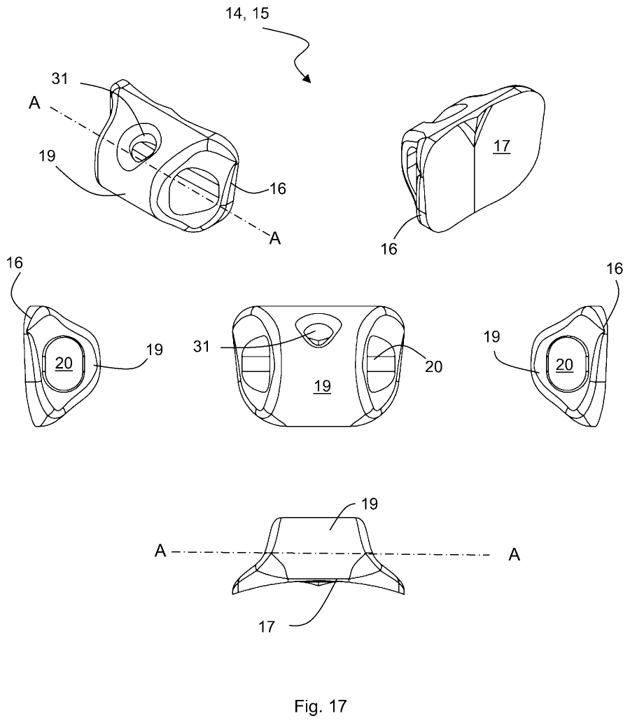

FIG. 17 shows a further embodiment of an attachment/anchor unit 14, 15 in which the cavity 20 extends entirely through the projection 19 so that the cavity 20 extends from its opening 21, to its further opposite opening 23, forming an O shaped bracket, or device 13.

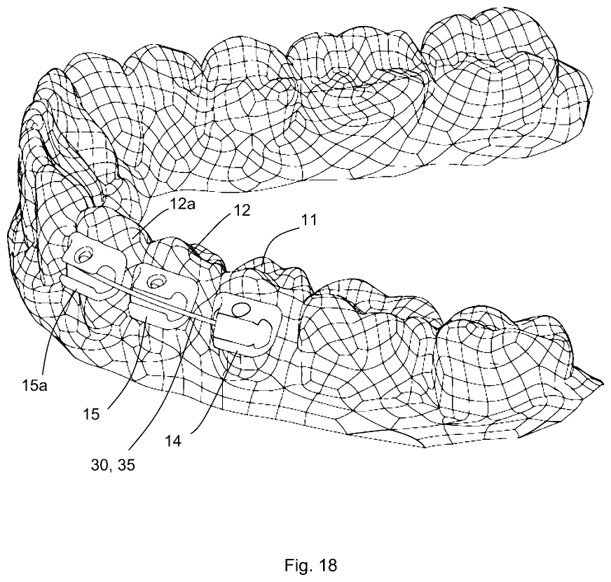

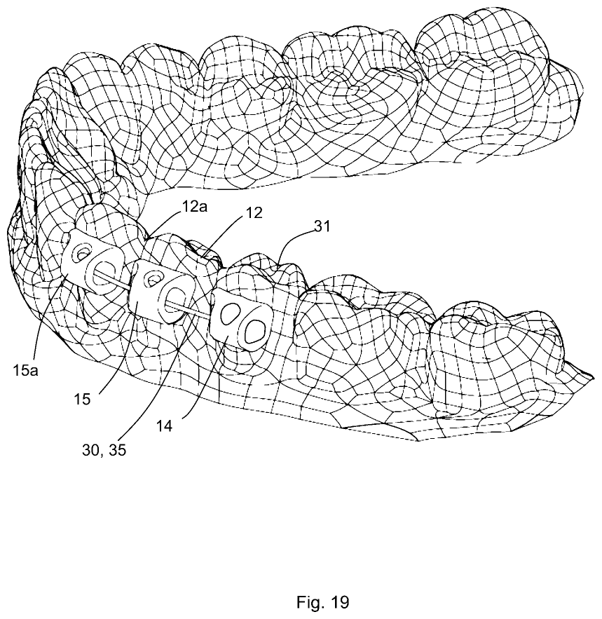

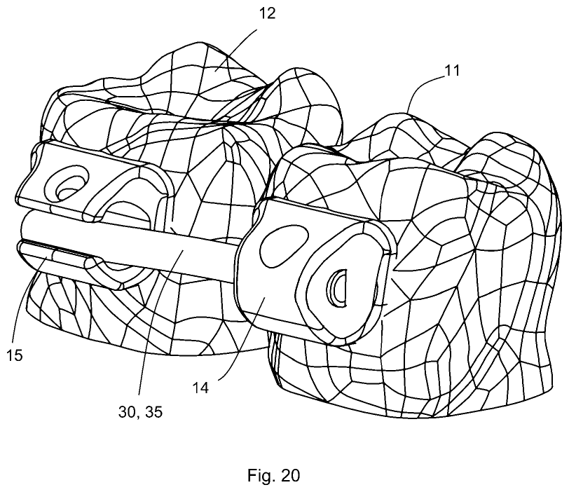

FIGS. 18 to 20 show the embodiments described above attached to adjacent teeth. It can be seen that same embodiments may be attached to adjacent teeth (see FIGS. 18 and 19) or a combination of the embodiments may be used (see FIG. 20).

In the embodiments described above the attachment/anchor units 14, 15 may be formed of metal, plastic, ceramic or other rigid or semi-rigid material. Additionally, the rod 35 may also be formed of metal, plastic, ceramic, or other rigid or semi-rigid material.

When filled with cement the attachment/anchor unit 14, 15 shown in FIGS. 13 to 20 has an external arcuate, or dome shape, such that it rounds into the tooth 14, 15. The external shape either individually or in an assembly 10 provides a comfortable and esthetic attachment facilitating the easy placement and removal of the overlaying clear orthodontic alignment tray and also facilitates the provision of a splinting bar resulting in the rigid fixation of the teeth thus prevent tilt thus providing anchorage.

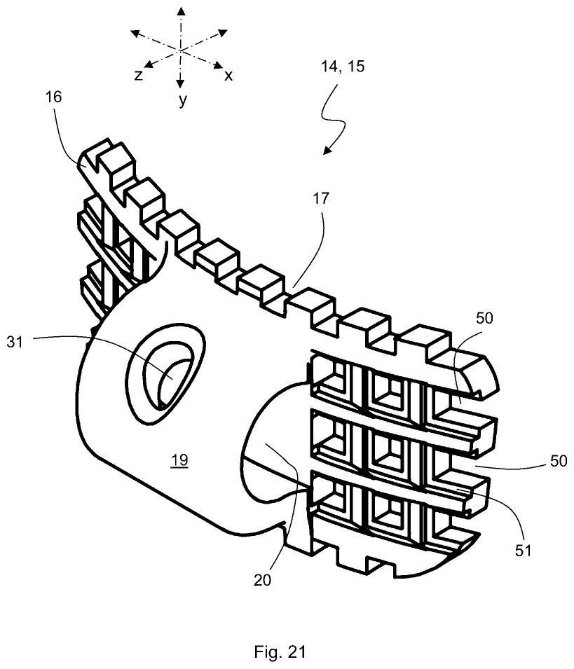

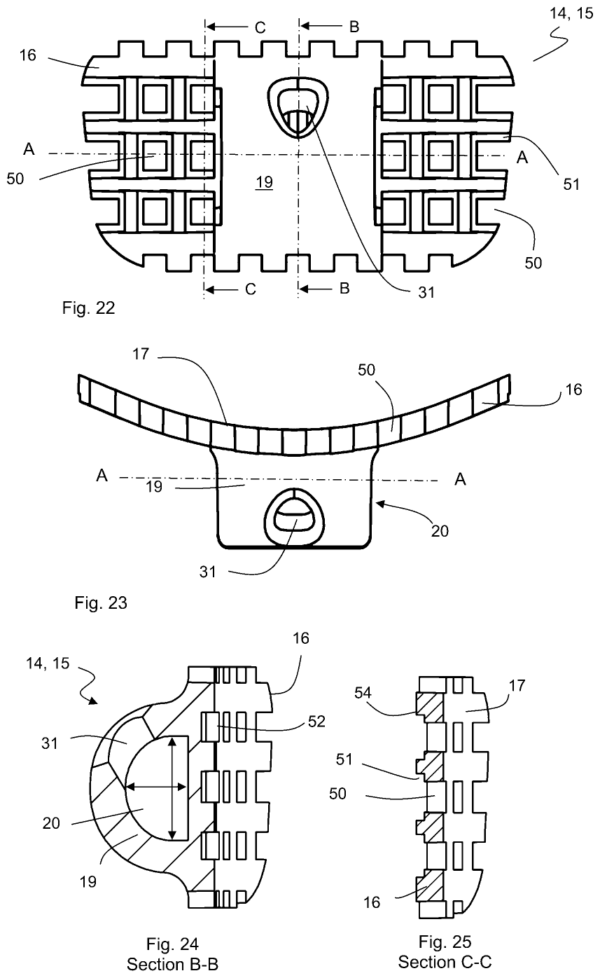

FIGS. 21 to 25 shown a further embodiment of an attachment/anchor unit 14, 15 intended for use with aligners or trays typically when it is desirable to not only reposition or straighten the anterior portion of the arch but also adjust the position of the molars and/or pre-molars. In this respect the attachment/anchor unit is intended to function as both an attachment, to allow the forces programmed into the aligner 41 to be transmitted with greater effectiveness through to the tooth without significant slippage; and as an anchor unit or component of an orthodontic anchorage assembly along with a substantially rigid connection member.

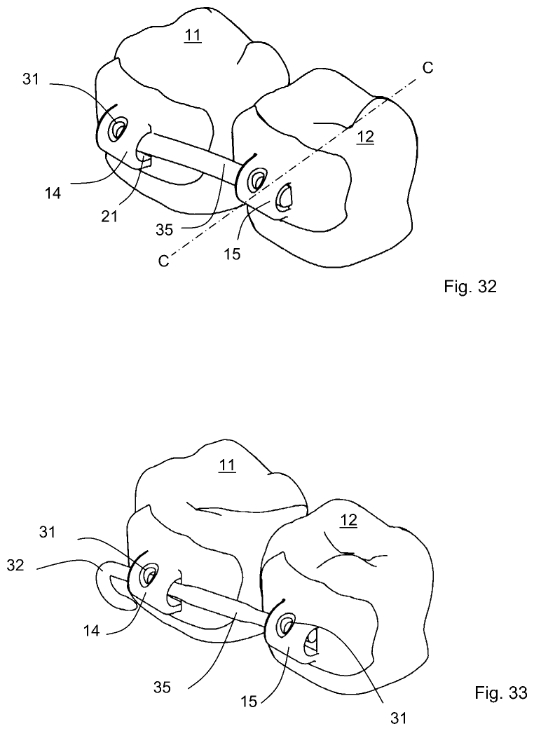

Accordingly, as seen in FIG. 32, there is provided an orthodontic anchorage assembly comprising at least first and second attachment/anchor unit 14, 15 to be attached to respective first and second teeth and an elongated connection member 35 extending from the first unit to the second unit.

In the embodiment depicted in FIGS. 21 to 25 like reference numbers have been used to indicate like features relative to the embodiments described above. Preferably the cavity 20 has a vertically elongate cross section (i.e. elongate in the plane that is parallel to the surface 18 and to the application surface of the respective tooth 11 or 12). In this embodiment, the cavity 20 has a vertically elongated D-shaped cross-section 24 corresponding to the arcuate projection 19 best seen in FIG. 24. The shape of the projection 19 (and corresponding cavity) is designed to minimise protrusion of the attachment/anchor unit into the buccal cavity in use. The exterior buccal facing surface of the projection 19 is devoid of sharp corners and surface irregularities to avoid irritation to the inside of the mouth and to assist an aligner or tray to slide over the attachment/anchor unit during placement and removal of the overlying tray.

In comparison, a larger or bulkier projection would have a more retentive or aggressive undercut (i.e. the inclined surface 40 as described above), which would make the plastic aligner 41 more difficult to apply or remove. The D-shaped cross-section of the cavity 20 (and the complementary D-shaped cross-section of the projection 19) may at least assist in minimising the aggression of the inclined surface 40, and keeping the inclined surface 40 relatively smooth so as to allow for easy application and removal of the plastic aligner 41. Conventional plastic aligners tend to be accommodate smaller projections 19, so any increase in size of the projection 19 may be disadvantageous to expectation of orthodontists, dentist and patients.

Additionally, the mounting portion 16 of the attachment/anchor unit 14, 15 is perforated with a plurality of apertures 50 extending therethrough. In this embodiment the apertures 50 are arranged in a grid array thereby forming a mesh like structure to provide increased surface area and mechanical engagement for bonding/cement agents. Furthermore, as best seen with reference to the cross-sectional view B-B shown in FIG. 25, the cross section of aperture 50 is stepped down in width along at least one perpendicular axis toward the tooth engaging surface 17 to enhance mechanical bonding by virtue of the cement flowing through the aperture 50 to engage the retentive step 51. Alternatively, the apertures 50 may be tapered such that the opening narrows toward the engaging surface 17. As best shown in FIG. 24, the mounting portion 16 also includes a plurality of blind apertures 52 that extend at least partly into the projection 19 to provide shear resistance bonding particularly when subjected to forces from the occlusal direction during chewing.

It will be appreciated that the mesh like mounting portion 16 may also be applied in respect of the earlier embodiments of the attachment/anchor unit 14, 15 described above. For example, the mesh like mounting portion 16 may be applicable to the embodiment as described in FIG. 15, with the projection 19 being in the form of the flange 36 extending transversely from the base 16 so as to form an n-shaped bracket, or the embodiment as described in FIG. 16 forming a C-shaped bracket, or the embodiment as described in FIG. 17 forming an 0-shaped bracket. The rigid splint 35 as described in the above embodiments may be applicable to any one of the embodiments having the mesh like mounting portion 16.

As discussed in respect of the above embodiments, the attachment/anchor unit 14 and 15 may be formed of metal, plastics, ceramic, composite, or other rigid or semi-rigid material or preferably a fiberglass reinforced engineering plastic material. The mesh mounting portion 16 and the projection 19 of the embodiment of FIGS. 21 to 25 may also be formed of the same or different materials with the mesh pad being made from a soft ductile material and the projection a substantially rigid material.

An advantage of the above-described configuration is that the attachment/anchor unit 14, 15 may be mass produced by injection moulding using relatively low-cost plastic materials (preferably fibre-reinforced plastic materials), as opposed to milling the unit or pad 14, 15 out of ceramic or unsightly metals, both of which are more costly in comparison to plastic materials. Whilst surfaces of plastic orthodontic brackets may be treated to assist with fixation to the tooth, it will be appreciated that mechanical retention by way of a mesh mounting portion provides a simple and reliable method of fixation. A further advantage of this mesh configuration is that with the use of injection moulding, a single unit size may be produced and then trimmed down (using scissors, clippers or special shears such as crown and collar shears) as required to fit the size of the tooth. A further advantage of this mesh configuration is that with the use of injection moulding, the plastic material may be heated and softened to be adapted to the shape of the tooth, if required. It will be appreciated that this advantage is also applicable in a mounting portion 16 that is formed from metal, as metal can also be flexed to fit the shape of the tooth.

It will further be appreciated that by providing a cavity 20 with a vertically elongate D-shaped cross-section, the substantially rigid connection member 35 (as described above in relation to the embodiment of FIGS. 7 to 12) that forms the splinting arrangement may also be shaped with a corresponding vertically elongate cross section to improve resistance to bending loads in the vertical plane (i.e. the plane that is parallel to the surface 18 and to the application surface of the respective tooth 11 or 12) by increasing the dimensions of the rod in the vertical plane. In particular, in this embodiment, as is best seen with reference to FIG. 34 the connection member is formed as a rod 35 having a vertically elongate D-shaped cross-section corresponding to the D-shaped cross section of the cavity 20. This configuration allows optimization of the balance between bulk and vertical strength of the bar whilst presenting the smooth arcuate surface to the cheek and deflecting food impacting from the occlusal.

Preferably the fit of the rod within the cavity is loose to allow for a degree of misalignment of between the respective cavities of each unit. Typically, the orthodontic anchorage assembly 10 is intended to passively fix the anchor teeth 11, 12 together to provide an anchor to prevent movement of each anchor tooth 11, 12 rather than actively move the anchor teeth. Accordingly, it is preferred that no unintended forces are introduced during construction of the orthodontic anchorage assembly for instance due to stress caused by misalignment and tight fit of the rod 35 within each cavity 20. Furthermore, as will be seen the loose fit also allows space for a flowable settable material.

It will be appreciated that the rod 35 may be made of any material suitable for splinting, such as metal (which may be coated with a tooth-coloured coating to enhance its appearance), plastics including fibre-reinforced plastics, and ceramics such as zirconium or the like. It will also be appreciated that the cement insertion duct 31 of the above-described embodiments may or may not be provided to facilitate the fixation of the rod 35 within the cavity 20.

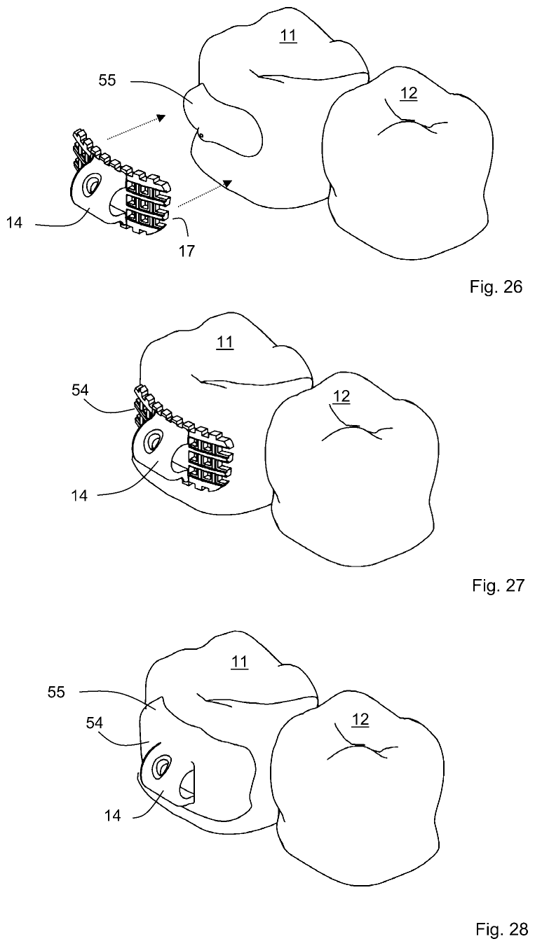

The steps for use are shown in FIGS. 26 to 32 and 33. In this example it is desirable to adjust both the positions of molar teeth 11, 12 within the arch and/or relatively as well as the teeth in anterior portion of the arch by means of aligners or trays. First, as seen in FIG. 26, a first attachment/anchor unit 14 is affixed to first tooth 11. A flowable settable substance 55 (for example, a semi-liquid or putty-like adhesive cement) is applied to the surface 18 of the respective tooth 11, and/or to the surface 17 of the mesh like mounting portion 16. The flowable substance flows into and is retained within the mesh apertures 51, 52 so as to improve bonding of the unit 14 to the tooth 11. The mounting portion 16 may be better retained on the tooth 11, 12 as the flowable substance is physically encapsulated within the apertures 51, 52. The flowable substance may be a self-curing, light curing or a dual curing cement glass ionomer. Additionally, as the flowable substance is applied to the surface 17 of the mesh mounting portion 16, the flowable substance will flow through the mesh openings 51, over outer facing surface 54 of the mounting portion 16, and fuse together. This may at least allow the attachment/anchor unit 14 to be better secured to the tooth 11, 12 for long-term attachment. Furthermore, additional flowable settable substance 55 may be applied against the outer facing surface 54 of the unit and “smoothed” off to fill the apertures and provide a smooth more comfortable surface for the wearer.

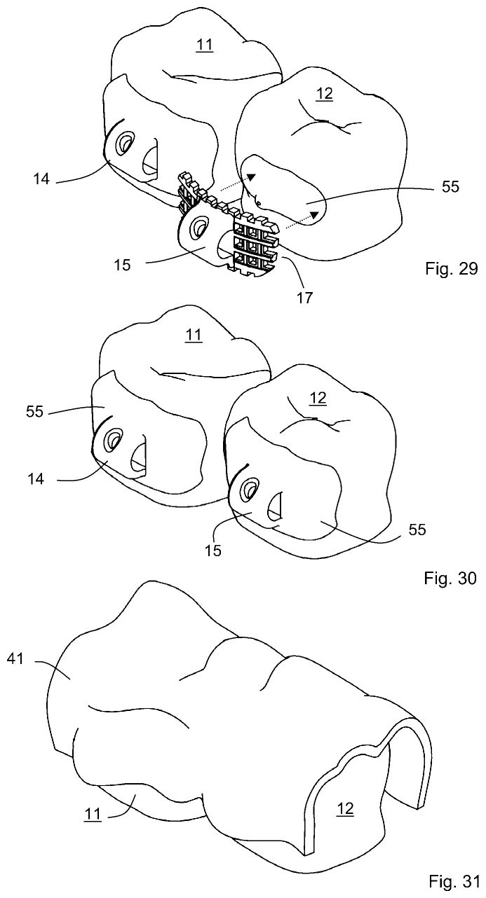

FIGS. 29 and 30 display the process of a second attachment/anchor unit being attached to a second respective tooth 12 in the same manner. Once both the units 14, 15 are fixed to respective teeth 11, 12, they may be used with a programmed series of trays or aligners 41 as exemplified in FIG. 31, to adjust the position of the molars. It will be appreciated that only a portion of the dental arch aligner 41 is illustrated. Herein the attachment/anchor units 14, 15 function as attachments enabling the aligner 41 greater purchase on the tooth thereby to allow the forces programmed into the aligner 41 to be transmitted with greater effectiveness through to the tooth. It will be appreciated that while in this example the position of two molars are adjusted, the attachment/anchor unit 14, 15 may be applied to any number of molars pre-molars and/or canines as required. Furthermore, while in this embodiment the teeth are adjacent, the attachment/anchor unit 14, 15 may be applied to teeth spaced in the arch.

Once the position of the molars has been adjusted as desired, the attachment/anchor unitl4, 15 are splinted together to form an anchorage assembly 10 and as shown in FIG. 32. As described above in relation to the previous embodiments of FIGS. 7 to 12 and 13 to 20, the substantially rigid connection member in the form of D-shaped cross section rod 35 may be inserted into the respective cavities 20 and fixed in place with a flowable settable material. In particular the flowable settable material is injected through each duct (transverse passages) 31 to engage the associated the respective end of the rod 35, so that upon setting, the rod is fixed to a respective projection 19. As a particular example the flowable substance may be an adhesive and delivered by an applicator 33 as shown in FIG. 2. In alternative embodiments the rigid connection member may be secured by means mechanical clamping threaded connector through passages 31 either alone or in combination with the flowable settable material.

Treatment of the anterior portion of the arch may continue by means of aligners or trays albeit with a revised program of aligners modified to incorporate allowance for the rod 35. It will be appreciated that the anchorage assembly provides resistance to movement of two splinted teeth 11, 12 significantly greater than the sum of the two teeth as individual units therefore greatly lowering the risk of the anchor teeth moving inadvertently.

In the embodiment shown in FIG. 33 the rod 35 includes an attachment hook 32 section provided to assist the dental professional in the attachment of other orthodontic devices to the orthodontic assembly 10, such as inter arch elastics, c-chain or elastic thread to provide forces to other teeth requiring additional force to move or rotate. As shown the hook is provided at one end of the bracket but may also be located

Although the invention has been described with reference to a preferred embodiment, it will be appreciated by those persons skilled in the art that the invention may be embodied in many other forms.

Spatially relative terms, such as “inner,” “outer,” “beneath,” “below,” “lower,” “above,” “upper,” along with anatomical terms such as “mesial”, “distal”, “occlusal”, “gingival”, “buccal” and “lingual” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

1.-61. (canceled)

62. An orthodontic method for splinting and repositioning teeth in a dental arch of a patient utilizing aligner trays, said method including the steps of:
fixing a first orthodontic attachment/anchor unit to a first tooth in the dental arch;
fixing a second orthodontic attachment/anchor unit to a second tooth in the dental arch;
applying a preliminary sequence of aligner trays to engage at least one of the first and second orthodontic attachment/anchor units to thereby reposition at least one of the first and second teeth
splinting the first and second teeth together by rigidly connecting the first and second orthodontic attachment/anchor units with a substantially rigid elongate splinting member thereby providing orthodontic anchorage; and
applying a sequence of aligner trays engaging at least one of the first and second orthodontic attachment/anchor units and a third tooth in said dental arch so as to reposition said third tooth.

63. The orthodontic method of claim 62 wherein said elongate splinting member includes a hook for the attachment of an orthodontic device including one of an inter arch elastics, c-chain or elastic thread.

64. The orthodontic method of claim 62 including a further step of:
removing said rigid elongate splinting member and said first and second orthodontic attachment/anchor units.

65. The orthodontic method of claim 62 wherein each orthodontic attachment/anchor unit includes:
a mounting portion, the mounting portion having a length in the mesial-distal direction, a height in the occlusal-gingival direction, a thickness in the buccal-lingual direction and a rear surface fixable to the tooth;
a projection extending transversely from the mounting portion in the buccal-lingual direction, the projection and the mounting portion defining a longitudinal cavity extending in the mesial-distal direction along a cavity axis, wherein the cavity is provided with an opening and configured to receive and locate said elongate splinting member that extends longitudinally into the cavity through the opening.

66. The orthodontic method of claim 65 wherein the projection includes an exterior facing surface having an arcuate profile.

67. The orthodontic method of claim 65 wherein wherein the cavity is elongate in the occlusal-gingival direction.

68. The orthodontic method of claim 67 wherein the cavity has a vertically elongate D-shaped cross section.

69. The orthodontic method of claim 65 wherein the mounting portion is perforated with a plurality of apertures extending therethrough.

70. The orthodontic method of claim 68 wherein, the elongate splinting member has an elongate D-shaped cross section corresponding to the vertically elongate D-shaped cross sections of the respective cavities of the first and second orthodontic attachment/anchor units.

71. The orthodontic method of claim 65 wherein the step of splinting the first and second teeth together includes fixing respective ends of the elongate splinting member to the first and second orthodontic attachment/anchor units with a flowable settable substance.

72. The orthodontic method of claim 62 including a further step prior to the step of splinting the first and second teeth together, of:
repositioning at least one of the first and second teeth by means of orthodontic wire.

73. An orthodontic attachment/anchor unit to be fixed to a tooth, the unit including:
a mounting portion, the mounting portion having a length in the mesial-distal direction, a height in the occlusal-gingival direction, a thickness in the buccal-lingual direction and a rear surface fixable to the tooth;
a projection extending transversely from the mounting portion in the buccal direction, the projection and the mounting portion defining a longitudinal cavity extending in the mesial-distal direction along a cavity axis, wherein the cavity is provided with an opening and configured to receive and locate an elongate splinting member that extends longitudinally into the cavity through the opening.

74. The orthodontic attachment/anchor unit of claim 73 wherein the projection includes an arcuate exterior facing surface.

75. The orthodontic attachment/anchor unit of claim 73 wherein the cavity is elongate in the occlusal-gingival direction.

76. The orthodontic attachment/anchor unit of claim 75 wherein the cavity has a vertically elongate D-shaped cross section.

77. The orthodontic attachment/anchor unit of claim 73 wherein the mounting portion is perforated with a plurality of apertures extending therethrough.

78. The orthodontic attachment/anchor unit of claim 77 wherein the apertures narrow toward the tooth engaging surface to provide mechanical engagement for bonding/cement agents.

79. The orthodontic attachment/anchor unit of claim 73 wherein, the projection includes a passage in communication with the cavity for receiving cement for delivery to the cavity to secure the elongate splinting member within to the cavity.

80. An orthodontic anchorage assembly including:
first and second orthodontic attachment/anchor units as recited in claim 73 to be fixed to a first tooth and a second tooth respectively;
a substantially rigid elongate splinting member receivable within a first cavity of the first orthodontic attachment/anchor unit and the second cavity of the second orthodontic attachment/anchor unit and extending between the first unit and the second unit; and
a settable material located in the first cavity and the second cavity, and engaging the elongate splinting member to rigidly fix the elongate splinting member to the first unit and the second unit.

81. The orthodontic anchorage assembly of claim 80 wherein, the elongate splinting member has a non circular cross section.

82. The orthodontic anchorage assembly of claim 81 wherein, the elongate splinting member has an oval or elliptical cross section.

83. The orthodontic anchorage assembly of claim 81 wherein the elongate splinting member has an elongate D-shaped cross section.
